(19) United States
(12) Patent Application Publication
(10) Pub. No.: US 2024/0232733 A9
(43) Pub. Date: Jul. 11, 2024

(54) INFORMATION PROCESSING APPARATUS

(71) Applicant: TOYOTA JIDOSHA KABUSHIKI KAISHA, Toyota-shi Aichi-ken (JP)

(72) Inventors: Hiroki TAKEISHI, Machida-shi Tokyo-to (JP); Shiro KOGA, Okazaki-shi Aichi-ken (JP)

(73) Assignee: TOYOTA JIDOSHA KABUSHIKI KAISHA, Toyota-shi Aichi-ken (JP)

(21) Appl. No.: 18/381,710

(22) Filed: Oct. 19, 2023

(30) Foreign Application Priority Data
Oct. 21, 2022 (JP) 2022-169488

(51) Int. Cl. G06Q 10/02; G06Q 50/30

(52) U.S. Cl. CPC G06Q 10/02; G06Q 50/30

(57) ABSTRACT

An information processing apparatus includes a controller configured to generate information for reserving a service to be provided to a vehicle. The controller is configured to generate and output a reservation slot reservable by a user of the service based on a time required for a provider of the service to move to a position of the vehicle.

### CROSS-REFERENCE TO RELATED APPLICATION

This application claims priority to Japanese Patent Application No. 2022-169488, filed on Oct. 21, 2022, the entire contents of which are incorporated herein by reference.

### TECHNICAL FIELD

The present disclosure relates to an information processing apparatus that provides reservation information for use of services for vehicles.

### BACKGROUND

A known apparatus allows a reservation receptionist to register a menu, which identifies services provided by the reservation receptionist, and resources for providing the services, and accepts a reservation for a reservation slot that is set using the menu and the resources. See, for example, Patent Literature (PTL) 1.

### CITATION LIST

### Patent Literature

PTL 1: JP 2018-032090 A

### SUMMARY

In a case in which the service provider moves, the reservation slots need to be calculated taking the movement into account.

It would be helpful to improve the calculation accuracy of reservation slots.

An information processing apparatus according to an embodiment of the present disclosure includes a controller configured to generate information for reserving a service to be provided to a vehicle. The controller is configured to generate and output a reservation slot reservable by a user of the service based on a time required for a provider of the service to move to a position of the vehicle.

According to the information processing apparatus in an embodiment of the present disclosure, the calculation accuracy of reservation slots can be improved.

### BRIEF DESCRIPTION OF THE DRAWINGS

In the accompanying drawings:

FIG. 1 is a block diagram illustrating an example configuration of an information processing system according to an embodiment;

FIG. 2 is a flowchart illustrating an example procedure for an information processing method according to an embodiment;

FIG. 3 is a flowchart illustrating an example procedure for generating reservation slots; and

FIG. 4 is a flowchart illustrating an example procedure for generating reservation slots that match a desired time.

### DETAILED DESCRIPTION

(Configuration of Information Processing System 1)

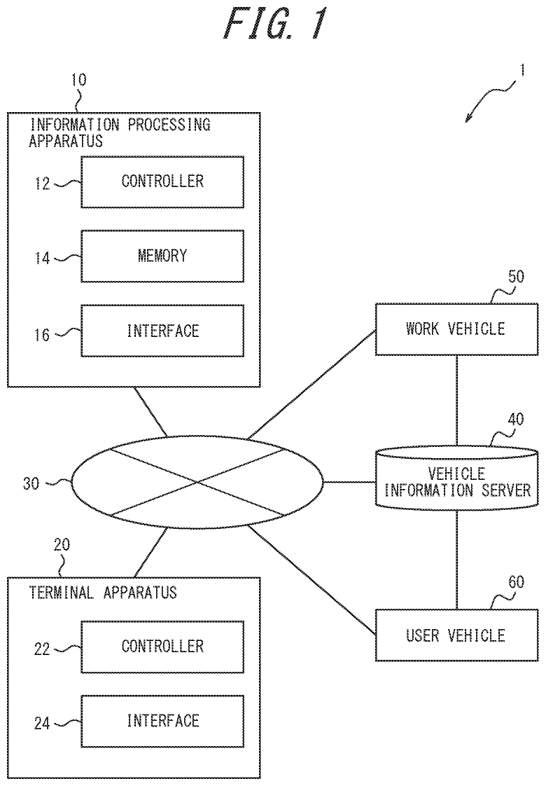

As illustrated in FIG. 1, an information processing system 1 according to an embodiment includes an information processing apparatus 10, a terminal apparatus 20, a work vehicle 50, and a user vehicle 60. The information processing system 1 provides a service to move the work vehicle 50 to the position of the user vehicle 60 for the work vehicle 50 or a worker transported by the work vehicle 50 to perform various types of work on the user vehicle 60. The information processing apparatus 10 accepts a reservation for work on the user vehicle 60 from the terminal apparatus 20 of the user and manages the operation of the work vehicle 50 based on the reservation. An example configuration of the information processing system 1 is described in detail below.

<Information Processing Apparatus 10>

The information processing apparatus 10 includes a controller 12, a memory 14, and an interface 16.

The controller 12 controls at least one component of the information processing apparatus 10. The controller 12 may be configured to include at least one processor. The “processor” is a general purpose processor, a dedicated processor specialized for specific processing, or the like in the present embodiment but not limited to these. The controller 12 may be configured to include at least one dedicated circuit. The dedicated circuit may include, for example, a field-programmable gate array (FPGA) or an application specific integrated circuit (ASIC). The controller 12 may be configured with the dedicated circuit instead of the processor, or may be configured with the dedicated circuit along with the processor.

The memory 14 is configured to include a semiconductor memory, a magnetic memory, an optical memory, or the like, for example, but is not limited to these. The memory 14 may function as, for example, a main memory, an auxiliary memory, or a cache memory. The memory 14 may be configured to include an electromagnetic storage medium, such as a magnetic disk. The memory 14 may be configured to include a non-transitory computer readable medium. The memory 14 stores any information or program to be used for operations of the information processing apparatus 10. The memory 14 may, for example, store a system program, an application program, or the like. The memory 14 may be included in the controller 12.

Information, data, or the like is outputted from and inputted to the controller 12 through the interface 16. The interface 16 may include a communication module for communication to other apparatuses, such as the terminal apparatuses 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The interface 16 may be configured to be capable of connecting to a communication module.

The interface 16 may be configured with an input device for accepting input of information, data, or the like from the user. The input device may be configured with, for example, a touch panel, a touch sensor, or a pointing device such as a mouse. The input device may be configured with a physical key. The input device may be configured with an audio input device, such as a microphone. The interface 16 may be configured to be capable of connecting to an external input device. The interface 16 may be configured to be capable of acquiring, from an external input device, information or data inputted to the external input device.

The interface 16 may be configured to include an output device that outputs information, data, or the like to the user. The output device may include, for example, a display device that outputs visual information, such as images, letters, or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker, that outputs audio information, such as voice. The output device is not limited to the above examples and may include various other devices. The interface 16 may be configured to be capable of connecting to an external output device. The interface 16 may be configured to be capable of outputting information or data to an external output device.

The information processing apparatus 10 may be configured to include a single server apparatus or a plurality of server apparatuses capable of communicating with each other. The information processing apparatus 10 may be implemented as a cloud server.

<Terminal Apparatus 20>

The terminal apparatus 20 is communicably connected to the information processing apparatus 10 and the like via the network 30. The terminal apparatus 20 includes a controller 22 and an interface 24.

The controller 22 may be configured with one or more processors or one or more dedicated circuits. The controller 22 may be configured to be identical or similar to the controller 12 of the information processing apparatus 10. The controller 22 may be configured to include a memory. The memory may be configured to be identical or similar to the memory 14 of the information processing apparatus 10.

The interface 24 may include input devices, output devices, or communication devices. The interface 24 may be configured to be identical or similar to the interface 16 of the information processing apparatus 10. The interface 24 may be communicably connected in a wired or wireless manner to the information processing apparatus 10 and the like. The interface 24 may include a display device. The terminal apparatus 20 may function as a display apparatus in the case of including a display device as the interface 24.

The terminal apparatus 20 may be carried by the user or may be installed at a predetermined location. The terminal apparatus 20 may be configured as a mobile terminal, such as a smartphone or a tablet, or a Personal Computer (PC), such as a notebook PC or a tablet PC. The terminal apparatus is not limited to the above examples and may include various devices. The number of terminal apparatuses 20 included in the information processing system 1 is not limited to one and may be two or more.

<Work Vehicle 50>

The work vehicle 50 may be a vehicle with an engine or an electric vehicle. Electric vehicles may include a Hybrid Electric Vehicle (HEV), a Plug-in Hybrid Electric Vehicle (PHEV), a Fuel Cell Electric Vehicle (FCEV), or a Battery Electric Vehicle (BEV). The number of work vehicles 50 managed by the information processing system 1 is not limited to one and may be two or more.

The work vehicle 50 may be configured to perform a power supply operation as the work on the user vehicle 60. The work vehicle 50 may be equipped with a power supply apparatus for supplying power to the user vehicle 60. The power supply apparatus may include at least one battery. The power supply apparatus may include a converter, inverter, or the like that controls the current or voltage supplied from the battery to the user vehicle 60. The work vehicle 50 may be configured to supply power to the user vehicle 60 from a battery of the work vehicle 50 itself. The work vehicle 50 may include a power supply cable or power supply connector for connecting to the user vehicle 60. The work vehicle 50 may include a device configured to provide a contactless power supply to the user vehicle 60. The operation to supply power from the work vehicle 50 to the user vehicle 60 may be performed by a worker of the work vehicle 50 or by the user of the user vehicle 60. The work vehicle 50 may be configured to supply power automatically to the user vehicle 60.

The work vehicle 50 may be configured to perform a refueling operation, an oil exchange operation, or the like as the work on the user vehicle 60. The work vehicle 50 may be configured to perform replacement of various components of the user vehicle 60, such as tires or filters, as the work on the user vehicle 60. The work vehicle 50 may be configured to transport a worker that performs work on the user vehicle 60.

The work vehicle 50 may include a communication device that is communicably connected to the information processing apparatus 10, the terminal apparatus 20, or the like. The work vehicle 50 may further include a positional information detection apparatus that acquires positional information. The positional information detection apparatus may output positional information for the work vehicle 50 to the information processing apparatus 10. The positional information detection apparatus may be configured to include a receiver compliant with a satellite positioning system. The receiver compliant with the satellite positioning system may be configured to include, for example, a Global Positioning System (GPS) receiver. The work vehicle 50 may be configured to be operated by a driver or configured to travel autonomously. The driver of the work vehicle 50 may be one of the workers themselves who are transported by the work vehicle 50.

<User Vehicle 60>

The user vehicle 60 may be a vehicle with an engine or an electric vehicle. The number of user vehicles 60 targeted for the work provided by the information processing system 1 is not limited to one and may be two or more. The user vehicle 60 may include a communication device that is communicably connected to the information processing apparatus 10, the terminal apparatus 20, or the like. The user vehicle 60 may further include a positional information detection apparatus that acquires positional information. The user vehicle 60 may be configured to be operated by a driver or configured to travel autonomously. The driver of the user vehicle 60 may be the user himself/herself. The user vehicle 60 is also referred to simply as the vehicle.

<Vehicle Information Server 40>

The information processing system 1 may optionally further include a vehicle information server 40. The vehicle information server 40 may acquire information about the work vehicle 50 or the user vehicle 60 and output the information to the information processing apparatus 10.

The vehicle information server 40 may include a processor or the like that functions as a controller. The vehicle information server 40 may include a memory or the like that functions as a storage. The vehicle information server may include a communication device that is communicably connected to the information processing apparatus 10 or the like. The vehicle information server may be configured to include a single server or a plurality of servers capable of communicating with each other. The vehicle information server 40 may be implemented as a cloud server.

(Operation Example of Information Processing System 1)

As described above, the information processing system 1 according to the present embodiment provides a service to move the work vehicle 50 to the position of the user vehicle 60 for the work vehicle 50 or a worker transported by the work vehicle 50 to perform various types of work on the user vehicle 60. The information processing apparatus 10 generates information for the user to reserve a service provided to the user vehicle 60 and outputs the information to the terminal apparatus 20 of the user. The terminal apparatus 20 outputs a reservation request from the user to the information processing apparatus 10. The information processing apparatus 10 manages operation of the work vehicle 50 based on the reservation. Hereinafter, example operations of the information processing apparatus 10 will be described with concrete examples.

<Generation of Reservation Slots>

The controller 12 of the information processing apparatus 10 calculates the time period in which the work vehicle 50 or the worker can provide the service as the information for the user to reserve the service. The controller 12 generates and outputs, to the terminal apparatus 20, the calculated time period as a time slot available for the user to reserve the service so that the user can select the time period to reserve the service. The time slot during which a user can reserve the service is also referred to as a reservation slot.

The controller 12 may generate reservation slots based on the type of service desired by the user. The service desired by the user is also referred to as the desired service. The terminal apparatus 20 may accept input of the desired service from the user and output the desired service to the information processing apparatus 10. The controller 12 may acquire the desired service from the terminal apparatus 20.

The controller 12 may generate reservation slots based on the position where the user desires that the service be provided. The position where the user desires that the service be provided is also referred to as the desired position. The desired position may be the current position of the user vehicle 60 or the position of the destination of the user vehicle 60. The terminal apparatus 20 may accept input of the desired position from the user and output the desired service to the information processing apparatus 10. The controller 12 may acquire the desired position from the terminal apparatus 20.

The controller 12 may generate reservation slots based on information about the work vehicle 50 or information about the user vehicle 60. Based on the reservation information assigned to the work vehicle 50, for example, the controller 12 may calculate a time period in which no other work is to be performed as an allocable time period for the work vehicle 50 to perform work on the user vehicle 60. Based on the desired position, or the position of the user vehicle 60 and the positions of the preceding and following work, the controller 12 may calculate the travel time from the position of the preceding or following work during the allocable time period to the position of the user vehicle 60. The controller 12 may generate a time period yielded by subtracting the travel time from the allocable time period as a slot in which service can be provided to the work vehicle 50. The controller 12 may generate the allocable service slots for one work vehicle 50 as reservation slots.

The controller 12 may calculate the length of time required to complete the work on the user vehicle 60 based on the desired service. The length of time required to complete the work on the user vehicle 60 is also referred to as the service time. In a case in which the work to be performed as the desired service is identified, the controller 12 may calculate the standard work time set for the identified work as the service time.

In a case in which the work to be performed as the desired service has not been identified, the controller 12 may estimate the work to be performed for the user vehicle 60 based on information about the condition of the user vehicle 60. The controller 12 may, for example, estimate a power supply operation, a refueling operation, or an oil exchange operation as the work to be performed on the user vehicle 60. The controller 12 may estimate the replacement of various components of the user vehicle 60, such as tires or filters, as the work to be performed on the user vehicle 60. The controller 12 may estimate the inspection of at least a portion of the user vehicle 60 as the work to be performed on the user vehicle 60. The controller 12 may estimate the cleaning of at least a portion of the user vehicle 60 as the work to be performed on the user vehicle 60. These examples are not limiting, and the controller 12 may estimate any of various tasks as the work to be performed on the user vehicle 60. The controller 12 may calculate the standard work time set for the estimated work as the service time.

In a case in which the length of the calculated service time is equal to or less than the length of the time period yielded by subtracting the travel time from the allocable time period, the controller 12 may generate the time period yielded by subtracting the travel time from the allocable time period as an available service slot or a reservation slot. In other words, the controller 12 may generate an available service slot or a reservation slot based on the length of the calculated service time.

The controller 12 may acquire information about the work vehicle 50 or information about the user vehicle 60 from the vehicle information server 40. The vehicle information server 40 may acquire information about the work vehicle 50 from the work vehicle 50 and store the information in a database. The vehicle information server 40 may acquire information about the user vehicle 60 from the user vehicle 60 and store the information in a database. The vehicle information server 40 may output the vehicle information stored in the database to the information processing apparatus 10 in response to a request from the information processing apparatus 10. The controller 12 may acquire information about the work vehicle 50 from the work vehicle 50. The controller 12 may acquire information about the user vehicle 60 from the user vehicle 60. The controller 12 may acquire the desired position from the terminal apparatus 20.

The controller 12 may generate an available service slot for each of the work vehicles 50. The controller 12 may generate a list of the available service slots for each work vehicle 50 and generate the reservation slots from the list. The controller 12 may, for example, generate a time period that corresponds to the available service slot of at least one work vehicle 50 as a reservation slot. The controller 12 may, for example, generate time periods that correspond to the available service slots of two or more work vehicles 50 as reservation slots. The controller 12 may, for example, generate time periods that correspond to the available service slots of work vehicles 50 for which the travel time to the user vehicle 60 is less than a predetermined time as reservation slots. These examples are not limiting, and the controller 12 may generate reservation slots from available service slots based on various conditions.

The controller 12 may acquire the time at which the user desires that the service be provided to the user vehicle 60. The time at which the user desires that the service be provided is also referred to as the desired time. The controller 12 may extract available service slots that match the desired time from the list of available service slots. The controller 12 may generate reservation slots from the extracted available service slots based on various conditions.

<Acceptance of Reservation>

The controller 12 of the information processing apparatus 10 outputs the generated reservation slots to the terminal apparatus 20. The controller 22 of the terminal apparatus 20 prompts for selection of the slot the user wishes to reserve from among the reservation slots using the interface 24 and outputs an application to reserve the slot selected by the user to the information processing apparatus 10. The controller 12 of the information processing apparatus 10 acquires the reservation request from the terminal apparatus 20 and confirms the reservation. The controller 12 generates reservation information and manages the operation of the work vehicle 50 based on the reservation information. The controller 12 may output the reservation information to the terminal apparatus 20. The controller 22 of the terminal apparatus 20 may acquire the reservation information and notify the user.

<Example Procedure for Information Processing Method>

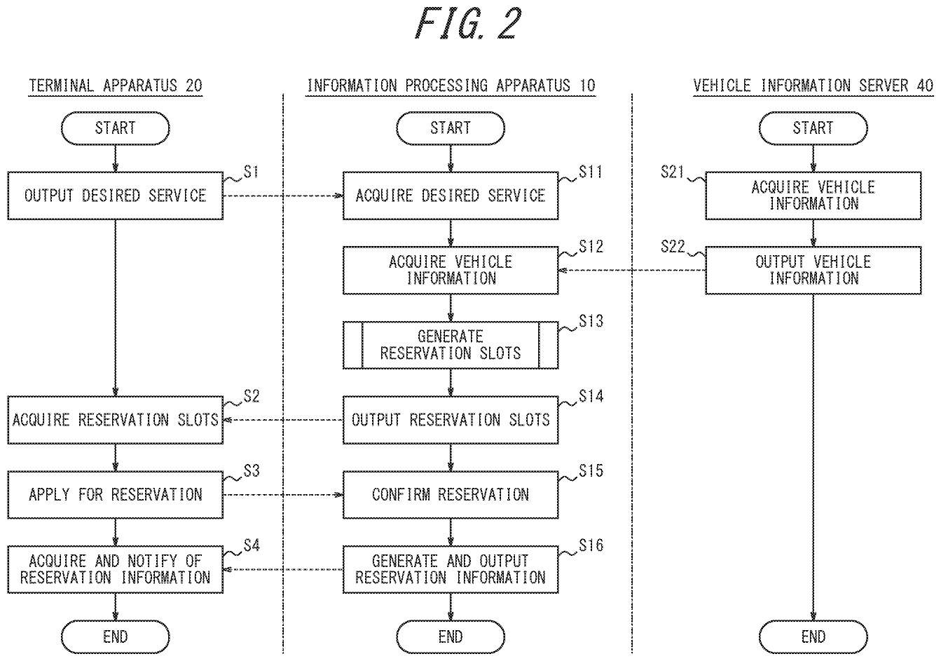

To provide a power supply service, the information processing system 1 according to the present embodiment may perform an information processing method that includes the procedures of the flowchart illustrated in FIG. 2. The information processing method may be implemented as an information processing program to be executed by the controller 12 of the information processing apparatus 10, the controller 22 of the terminal apparatus 20, or the controller of the vehicle information server 40. The information processing program may be stored on a non-transitory computer readable medium.

The controller 22 of the terminal apparatus 20 outputs the user's desired service, inputted to the interface 24, to the information processing apparatus 10 (step S1). The controller 12 of the information processing apparatus 10 acquires the desired service (step S11).

The vehicle information server 40 acquires vehicle information, which includes information about the work vehicle 50 or information about the user vehicle 60 (step S21). The vehicle information server 40 outputs the vehicle information to the information processing apparatus 10 (step S22). The vehicle information server 40 may output the vehicle information in response to a request from the information processing apparatus 10. After executing the procedure of step S22, the vehicle information server 40 ends the execution of the procedure in the flowchart of FIG. 2. The vehicle information server 40 may acquire the vehicle information at appropriate times.

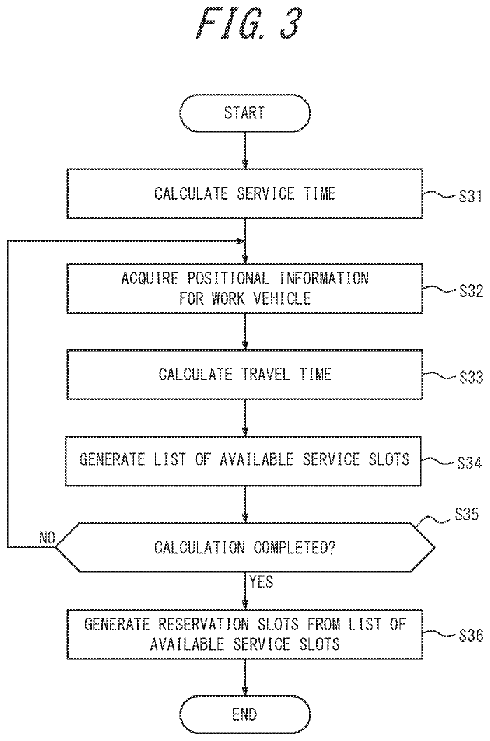

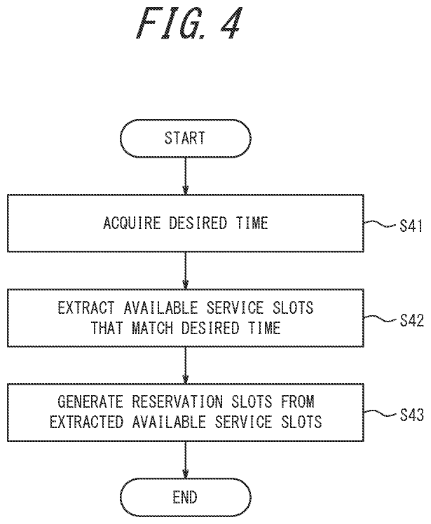

The controller 12 of the information processing apparatus 10 acquires the vehicle information (step S12). The controller 12 generates reservation slots based on the desired service and the vehicle information (step S13). Specifically, the controller 12 may generate the reservation slots by executing the procedures in the flowcharts illustrated in FIGS. 3 and 4, described below. The controller 12 outputs the generated reservation slots to the terminal apparatus 20 (step S14).

The controller 22 of the terminal apparatus 20 acquires the reservation slots (step S2). The controller 22 notifies the user of the reservation slots on the interface 24, accepts the input by the user of reservation details selected from a reservation slot, and submits an application for reservation to the information processing apparatus 10 (step S3).

The controller 12 of the information processing apparatus 10 confirms the reservation based on the reservation application (step S15). The controller 12 generates reservation information and outputs the reservation information to the terminal apparatus 20 (step S16). After performing the procedure of step S16, the controller 12 can end execution of the procedures in FIG. 2. The controller 12 may manage the operation of the work vehicle 50 based on the reservation information.

The controller 22 of the terminal apparatus 20 acquires the reservation information and notifies the user (step S4). After performing the procedure of step S4, the controller 22 can end the execution of the procedures in FIG. 2.

The controller 12 of the information processing apparatus 10 may perform an information processing method including the procedures of the flowchart illustrated in FIG. 3 as the procedures for generating reservation slots in step S13 of FIG. 2.

The controller 12 calculates the service time based on the desired service (step S31). The controller 12 acquires the positional information for one of the work vehicles 50 that the controller 12 manages (step S32). The controller 12 calculates the travel time based on the desired position and the position of the work vehicle 50 (step S33). The controller 12 calculates the available service slots for the target work vehicle 50 and generates a list of available service slots (step S34). The controller 12 determines whether the calculation of the available service slots has been completed for all work vehicles 50 targeted for the calculation of available service slots (step S35).

In a case in which the controller 12 has not completed the calculation (step S35: NO), the controller 12 repeats the procedures of steps S32 through S34 for the remaining work vehicles 50 and updates the list of available service slots. In a case in which the controller 12 has completed the calculation (step S35: YES), the controller 12 generates reservation slots from the list of available service slots (step S36). After performing the procedure of step S36, the controller 12 proceeds to the procedure to output the reservation slots in step S14 of FIG. 2.

The controller 12 of the information processing apparatus 10 may perform an information processing method including the procedures of the flowchart illustrated in FIG. 4 to generate the reservation slots taking into account the desired time in the procedures for generating the reservation slots in step S36 of FIG. 3. The controller 12 acquires the desired time (step S41). The controller 12 extracts available service slots that match the desired time from the list of available service slots (step S42). The controller 12 generates reservation slots from the extracted available service slots based on various conditions (step S43). After performing the procedure of step S43, the controller 12 proceeds to the procedure to output the reservation slots in step S14 of FIG. 2.

### SUMMARY

As described above, in the information processing system 1 according to the present embodiment, the information processing apparatus 10 generates reservation slots based on the time required for the service provider to move to the position of the user vehicle 60 and accepts a reservation from the user. Here, as a first comparative example, a system that accepts a reservation in a case in which the user moves to the service provision location is considered. In the system according to the first comparative example, users need to make a reservation taking into account their own travel time themselves. By contrast, the information processing system 1 according to the present embodiment can generate reservation slots taking into account the travel time of the service provider. With this approach, users do not need to take travel time into account. The travel time can also be calculated with higher accuracy than the travel time assumed by the user. The calculation accuracy of the reservation slots can consequently be improved. The reservation slots can be expanded by the improvement in the calculation accuracy of reservation slots. User convenience can thereby be improved.

As a second comparative example, a system that accepts reservations with a predetermined length of time for service is considered. In the system according to the second comparative example, the user needs make a reservation knowing the length of time required for the service. By contrast, the information processing system 1 according to the present embodiment can accept reservations for services with a variable length of service time in accordance with the length of service time. With this approach, users do not need to know the service time. The service time can also be calculated with higher accuracy than the service time assumed by the user. The calculation accuracy of the reservation slots can consequently be improved. The reservation slots can be expanded by the improvement in the calculation accuracy of reservation slots. User convenience can thereby be improved.

### Other Embodiments

An example configuration of an information processing system 1 according to another embodiment will be described below.

<Prediction of Service Patterns>

The controller 12 of the information processing apparatus 10 may estimate the work to be performed on the user vehicle 60 based on the information about the condition of the user vehicle 60, as described above. In other words, the controller 12 may estimate the service to be provided to the user vehicle 60 based on the information about the condition of the user vehicle 60. The controller 12 may estimate only one service to be provided to the user vehicle 60 or may predict a pattern of a plurality of services as the service to be provided to the user vehicle 60. The controller 12 may predict a pattern of a plurality of services that could be services to be provided to the user vehicle 60 in a case in which at least a portion of the information about the condition of the user vehicle 60 is not acquired. The controller 12 may, for example, predict a pattern of services that combines an inspection of the user vehicle 60 with at least one of replacement, cleaning, or the like.

In a case in which a pattern of a plurality of services is predicted, the controller 12 may estimate the service time for each predicted pattern. The controller 12 may generate reservation slots based on the estimated service times for each pattern. The controller 12 may, for example, generate reservation slots in accordance with the longest estimate among the estimated service times for each pattern. The controller 12 may calculate the expected values of the service time by weighting the estimated service times by the probability that the services of each pattern will be provided and generate the reservation slots in accordance with the expected values. The controller 12 may generate reservation slots in accordance with the average estimated service time for each pattern.

By service patterns being predicted as described above, the service time can be calculated to a high degree of accuracy. The calculation accuracy of the reservation slots can consequently be improved. The reservation slots can be expanded by the improvement in the calculation accuracy of reservation slots. User convenience can thereby be improved.

<Reservations from Plurality of Users>

The controller 12 of the information processing apparatus 10 may be configured to accept reservations from a plurality of users in parallel. The controller 12 may, for example, set the reservation slots presented to a first user as a tentative reservation for the first user. In a case of presenting reservation slots to a second user, the controller 12 may generate reservation slots for the second user within a time period excluding the time period of the tentative reservation for the first user and present the reservation slots to the second user. In a case of confirming the reservation for the first user, the controller 12 may release the time period that was set as the tentative reservation for the first user and may re-generate the reservation slots to be presented to other users such as the second user. In this way, users can confirm reservations within the presented reservation slots. To put it another way, it is possible to avoid a situation in which a reservation cannot be made at a time selected from among reservation slots. User convenience can thereby be improved.

The controller 12 may reflect, in real time, a status of a reservation operation by each user in the plurality of users of the service, or a result of acceptance of the reservation of at least some of the users, in the reservation slots presented to each of the users. In other words, the controller 12 may generate and output reservation slots for each user in the plurality of users while reflecting in real time the status of the reservation operation by each of the users or the result of acceptance of the reservation. With this approach, the reservation slots presented to each user can be expanded. User convenience can thereby be improved.

<Reservations for Plurality of Service Providers>

The controller 12 of the information processing apparatus 10 may accept reservations for each provider in a plurality of providers of services. The controller 12 may generate, and output to the terminal apparatus 20 of the user, reservation slots for the provider selected by the user from among the plurality of providers of services. The controller 12 may generate and output reservation slots for each user in the plurality of users of services while reflecting in real time the status of the reservation operation by each of the users or the result of acceptance of a reservation by each provider in the plurality of providers of services. With this approach, the reservation slots presented to each user can be expanded. User convenience can thereby be improved.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each element, each step, or the like can be rearranged without logical inconsistency, and a plurality of elements, steps, or the like can be combined into one or divided.

1. An information processing apparatus comprising a controller configured to generate information for reserving a service to be provided to a vehicle, wherein
the controller is configured to generate and output a reservation slot reservable by a user of the service based on a time required for a provider of the service to move to a position of the vehicle.

2. The information processing apparatus according to claim 1,
wherein the controller is configured to calculate a length of a service time which is a time required to complete work on the vehicle as a service to be provided to the vehicle based on information about a condition of the vehicle, and
generate and output the reservation slot based on the length of the service time.

3. The information processing apparatus according to claim 1,
wherein the controller is configured to predict at least one pattern of services to be provided to the vehicle in a case in which at least a portion of information about a condition of the vehicle is not acquired, and
generate and output the reservation slot based on a time required to provide the services in each predicted pattern.

4. The information processing apparatus according to claim 2,
wherein the controller is configured to predict at least one pattern of services to be provided to the vehicle in a case in which at least a portion of the information about the condition of the vehicle is not acquired, and
generate and output the reservation slot based on a time required to provide the services in each predicted pattern.

5. The information processing apparatus according to claim 1, wherein the controller is configured to set a reservation slot presented to a first user among users of the service as a tentative reservation, generate a reservation slot for a second user within a time period excluding a time period of the tentative reservation for the first user, and present the reservation slot for the second user to the second user.

6. The information processing apparatus according to claim 2, wherein the controller is configured to set a reservation slot presented to a first user among users of the service as a tentative reservation, generate a reservation slot for a second user within a time period excluding a time period of the tentative reservation for the first user, and present the reservation slot for the second user to the second user.

7. The information processing apparatus according to claim 3, wherein the controller is configured to set a reservation slot presented to a first user among users of the service as a tentative reservation, generate a reservation slot for a second user within a time period excluding a time period of the tentative reservation for the first user, and present the reservation slot for the second user to the second user.

8. The information processing apparatus according to claim 4, wherein the controller is configured to set a reservation slot presented to a first user among users of the service as a tentative reservation, generate a reservation slot for a second user within a time period excluding a time period of the tentative reservation for the first user, and present the reservation slot for the second user to the second user.

9. The information processing apparatus according to claim 1,
wherein the controller is configured to generate and output a reservation slot for a provider selected by a user of the service from among a plurality of providers of the service, and
generate and output a reservation slot for each user in a plurality of users of the service while reflecting in real time a status of a reservation operation by each user in the plurality of users of the service or a result of acceptance of a reservation by each provider in the plurality of providers of the service.

10. The information processing apparatus according to claim 2, wherein the controller is configured to
generate and output a reservation slot for a provider selected by a user of the service from among a plurality of providers of the service, and
generate and output a reservation slot for each user in a plurality of users of the service while reflecting in real time a status of a reservation operation by each user in the plurality of users of the service or a result of acceptance of a reservation by each provider in the plurality of providers of the service.

11. The information processing apparatus according to claim 3, wherein the controller is configured to
generate and output a reservation slot for a provider selected by a user of the service from among a plurality of providers of the service, and
generate and output a reservation slot for each user in a plurality of users of the service while reflecting in real time a status of a reservation operation by each user in the plurality of users of the service or a result of acceptance of a reservation by each provider in the plurality of providers of the service.

12. The information processing apparatus according to claim 4, wherein the controller is configured to
generate and output a reservation slot for a provider selected by a user of the service from among a plurality of providers of the service, and
generate and output a reservation slot for each user in a plurality of users of the service while reflecting in real time a status of a reservation operation by each user in the plurality of users of the service or a result of acceptance of a reservation by each provider in the plurality of providers of the service.

13. The information processing apparatus according to claim 5,
wherein the controller is configured to generate and output a reservation slot for a provider selected by a user of the service from among a plurality of providers of the service, and
generate and output a reservation slot for each user in a plurality of users of the service while reflecting in real time a status of a reservation operation by each user in the plurality of users of the service or a result of acceptance of a reservation by each provider in the plurality of providers of the service.

14. The information processing apparatus according to claim 6, wherein the controller is configured to
generate and output a reservation slot for a provider selected by a user of the service from among a plurality of providers of the service, and
generate and output a reservation slot for each user in a plurality of users of the service while reflecting in real time a status of a reservation operation by each user in the plurality of users of the service or a result of acceptance of a reservation by each provider in the plurality of providers of the service.

15. The information processing apparatus according to claim 7, wherein the controller is configured to
generate and output a reservation slot for a provider selected by a user of the service from among a plurality of providers of the service, and
generate and output a reservation slot for each user in a plurality of users of the service while reflecting in real time a status of a reservation operation by each user in the plurality of users of the service or a result of acceptance of a reservation by each provider in the plurality of providers of the service.

16. The information processing apparatus according to claim 8, wherein the controller is configured to
generate and output a reservation slot for a provider selected by a user of the service from among a plurality of providers of the service, and
generate and output a reservation slot for each user in a plurality of users of the service while reflecting in real time a status of a reservation operation by each user in the plurality of users of the service or a result of acceptance of a reservation by each provider in the plurality of providers of the service.
